(19) United States
(12) Patent Application Publication
(10) Pub. No.: US 2005/0276241 A1
(43) Pub. Date: Dec. 15, 2005

(54) Wireless LAN with fragmentation for bluetooth coexistence

(76) Inventors: Adriaan Kamerman, Nieuwegein (NL); Ernestus van der Horst, Amsterdam (NL); Roland Hellfajer, Bochum (DE); Christian Durdodt, Bochum (DE)

Correspondence Address: MANELLI DENISON & SELTER PLLC, 7th Floor, 2000 M Street, N.W., Washington, DC, 20036-3307, US

(21) Appl. No.: 10/893,987

(22) Filed: Jul. 20, 2004

Related U.S. Application Data
(60) Provisional application No. 60/578,311, filed on Jun. 10, 2004.

(51) Int. Cl. H04Q 7/00

(52) U.S. Cl. 370/328

(57) ABSTRACT

Mutual interference experienced between co-located WLAN and BT devices is minimized. An improved wireless local area network (WLAN) scheme using fragmentation, that itself mitigates BLUETOOTH™—related interference, without relying on a presumed cooperation from co-located BLUETOOTH devices. The use of fragmentation in a WLAN network allows a longer concatenated period of WLAN activity, with corrupted segments being retried. Therefore, the chances of getting a full frame transferred during the repetitive interference by BT voice is greatly improved. A coexistence scheme is provided that is active in the MAC layer of a Wireless LAN (WLAN) device, aiming to make optimal use of the non-occupied BT slots for both uplink and downlink WLAN communication. The co-existence scheme improves throughput performance for active co-located WLAN and BT devices. Because the coexistence scheme is link-based instead of global and is enabled only when required, frame loss and fragmentation are minimized, leading to less network overhead.

This application claims priority from U.S. Provisional Application No. 60/578,311, entitled “Wireless LAN With Fragmentation For BLUETOOTH Coexistence”, to Durdodt et al., filed Jun. 10, 2004, the entirety of which is expressly incorporated herein by reference.

### BACKGROUND OF THE INVENTION

1. Field of the Invention

The present invention relates to Wireless local area network (Wireless LAN) or (WLAN), which accommodates co-location with BLUETOOTH™ (BT) systems sharing the same radio spectrum.

2. Background of Related Art

Background of IEEE 802.11 WLAN

IEEE 802.11a, 802.11b and IEEE 802.11g are standards for WLAN systems that operate in 5, 2.4 and 2.4 GHz bands, respectively. The 802.11 standard focuses on the medium access control (MAC) and the physical layer (PHY) protocols for access point based networks and ad-hoc networks.

In access point based networks, the stations within a group or cell can communicate only directly to the access point (AP). This AP forwards messages to the destination station within the same cell or through a wired or wireless distribution system to another AP, from which such messages arrive finally at the destination station. In ad-hoc networks, the stations operate on a peer-to-peer level and there is no AP or distribution system.

802.11 includes the extensions 11a, 11b, and 11g. Extension 11b is for a high rate complementary code keying (CCK) PHY, providing data rates 11 and 5.5 Mbits/s, as well as the basic DSSS bit rates of 2 and 1 Mbits/s within the same 2.4-2.5 GHz ISM band. Extension 11a is for a high data rate Orthogonal Frequency Division Multiplexing (OFDM) modulation PHY standard providing data rates in the range of 6 to 54 Mbits/s in the 5 GHz band. Extension 11g uses the same modulation and data rates as 11a, but in the 2.4 GHz band.

The 802.11 MAC also describes the way in which beacon frames are sent by the AP. The 802.11 MAC also includes a set of management frames which allow a station to scan actively for other APs on any channel available in the band by means of Probe request frames (to be responded by the AP by a Probe response frame). In 802.11 AP-based networks the stations associate to an AP with a corresponding network name (SSID, Service Set Identifier). Normally, a station associates (by means of an Association request frame to be responded by an Association response frame) to the AP that it receives the best, which in general is the nearest AP.

Background of BLUETOOTH™

BT wireless technology is a short-range communications system intended to replace the cable(s) connecting portable and/or fixed electronic devices. The system offers services that enable the connection of devices and the exchange of a variety of classes of data between these devices.

By way of example, the BT system operates in the 2.4 GHz ISM band from 2400 to 2483.5 MHz. 79 RF channels are spaced 1 MHz apart. To comply with out-of-band regulations in each country, a guard band is used at the lower and upper band edge. The frequencies of the k-channels are determined by:
fₖ=2402+k MHz, k=0, . . . , 78.

The BT system employs a frequency hop transceiver to combat interference and fading. RF operation uses a shaped, binary FM modulation to minimize transceiver complexity. The symbol rate is 1 Megasymbol per second (Ms/s), supporting a bit rate of 1 Megabit/second (Mb/s). The modulation is Gaussian Frequency Shift Keying (GFSK) with a bandwidth bit period product (also “BT”) BT=0.5, and a modulation index of between 0.28 and 0.35. The BLUETOOTH receiver sensitivity level is defined as the input level for which a raw bit error rate (BER) of 0.1% is met. The BER shall be <0.1% for all specified signal-to-interference ratios. For example, adjacent interference in 3 MHz distance, with a power level 40 dB below the receive signal. The receiver sensitivity is below or equal to −70 dBm. The transmitters are classified into three power classes, with a maximum output power of 0 dBm, 4 dBm and 20 dBm, respectively. In distance of 3 MHz or greater from the transmit frequency, the maximal allowed transmit spurious emission is −40 dBm.

During BT's typical operation, a physical radio channel is shared by a group of devices that are synchronized to a common clock and frequency hopping pattern. One device provides the synchronization reference and is known as the master. All other devices are known as slaves. A group of devices synchronized in this fashion form a piconet. This is the fundamental form of communication in the BT wireless technology.

Devices in a piconet use a specific frequency hopping pattern, which is algorithmically determined by certain fields in the BT address and clock of the master. The basic hopping pattern is a pseudo-random ordering of the 79 frequencies in the ISM band. The hopping pattern may be adapted to exclude a portion of the frequencies that are used by interfering devices. The adaptive frequency hopping (AFH) technique improves BLUETOOTH coexistence with static (i.e., non-hopping) ISM systems when they are not co-located, e.g., in a WLAN.

The BT physical channel is sub-divided into time units known as slots, with a duration of 625 us each. Data is transmitted between BLUETOOTH devices in packets, which are positioned in these slots. When circumstances permit, a number of consecutive slots may be allocated to a single packet. Frequency hopping takes place between the transmission and reception of packets. When AFH is enabled, the slave responds with its packet on the same frequency that was used by the master to address the slave.

BT technology provides the effect of full duplex transmission through the use of a Time-Division Duplex (TDD) scheme. All devices participating in the piconet are time-synchronized and hop-synchronized to the channel. The time slots are numbered according to the most significant 27 bits of the BT clock CLK of the piconet master. The slot numbering ranges from 0 to 2²⁷−1 and is cyclic with a cycle length of 2²⁷. The time slot number is denoted as k.

FIG. 4 shows a TDD scheme used where master and slave alternatively transmit.

In particular, as shown in FIG. 4, the packet start is aligned with the slot start. Packets may extend over up to five time slots. The term ‘slot pairs’ is used to indicate two adjacent time slots starting with a master-to-slave transmission slot.

Within a physical channel, a physical link is formed between any two devices that transmit packets in either direction to one another. A physical link is established between each slave and the master. The physical link is used as a transport for one or more logical links that support unicast synchronous, asynchronous and isochronous traffic, and broadcast traffic.

Asynchronous connection-oriented (ACL) logical transport is used to carry control signals and best effort asynchronous user data. Asynchronous links provide a method for transporting data that has no time-based characteristics.

Synchronous links provide a method of associating the BT piconet clock with the transported data. This is achieved by reserving regular slots on the physical channel, and transmitting fixed size packets at these regular intervals. Such links are suitable for constant rate isochronous data.

Isochronous links provide a method for transporting data that has time-based characteristics. The data rate on the link need not be constant (this being the main difference from synchronous links).

The synchronous connection-oriented (SCO) logical transport is a symmetric, point-to-point channel between the master and a specific slave. The SCO logical transport reserves slots on the physical channel and can therefore be considered as a circuit-switched connection between the master and the slave. SCO logical transports carry 64 kbit/s of information synchronized with the piconet clock. Typically this information is an encoded voice stream. Three different SCO configurations exist, offering a balance between robustness, delay and bandwidth consumption.

The extended synchronous connection-oriented (eSCO) logical transport is a symmetric or asymmetric, point-to-point link between the master and a specific slave. eSCO links offer a number of extensions over the standard SCO links, in that they support a more flexible combination of packet types and selectable data contents in the packets and selectable slot periods, allowing a range of synchronous bit rates to be supported.

The packets used on the piconet are related to the logical transports they are used in. Three logical transports are defined: the SCO logical transport, the eSCO logical transport, and the ACL logical transport. For each of these logical transports, 16 different packet types can be defined. The packet types are divided into four segments. The first segment is reserved for control packets. All control packets occupy a single time slot. The second segment is reserved for packets occupying a single time slot. The third segment is reserved for packets occupying three time slots. The fourth segment is reserved for packets occupying five time slots.

Packages are partitioned in each segment in HV packages. HV and DV packets are used on the synchronous SCO logical transport. HV packets do not include a CRC and are not re-transmitted. DV packets include a CRC on the data section, but not on the synchronous data section. The data section of DV packets are re-transmitted. SCO packets may be routed to the synchronous I/O port. Four packets are allowed on the SCO logical transport: HV1, HV2, HV3 and DV. These packets are typically used for 64 kb/s speech transmission but may be used for transparent synchronous data.

The payload length of HV1, HV2 and HV3 packets is fixed at 240 bits. The bytes are protected with a rate ⅓ FEC, ⅔ FEC and non FEC, respectively. Therefore 10, 20 or 30 information bytes are carried by the respective package.

Background of Invention

WLAN communication in the 2.4 GHz band can be disturbed by BT communication. Mutual interference between WLAN and BT occurs in the presence of active BT devices that are, e.g., within close range of one another, embedded in the same computer, etc. (i.e., co-located devices).

WLAN and BT devices can corrupt each other's reception due to this interference. Such corruption is the result of a near/far problem. The interfering nearby radio transmitter gives a higher receive level than the desired far away radio transmitter. The specific risk of received frame corruption depends on factors such as the transmit levels, the distances (nearby and far away), the frequencies used, and the selectivity and RF blocking level of the respective receivers.

For a collision to occur in BLUETOOTH™, or indeed a WLAN conforming to the industry standard IEEE 802.11g or IEEE 802.11b, their signals must coincide in both frequency and time. Since BLUETOOTH™ packets are of variable lengths, as are 802.11g protocol service data units (PSDUs or packets), a simple mathematical relationship expressing the probabilities of packets coinciding in time between these two systems cannot be expressed conveniently. However, for simplicity purposes, the main parameters in predicting interference are packet durations of the two systems, the BLUETOOTH™ frequency hop pattern, and the relative strength of the interferer(s) on the system.

FIG. 5 shows a frequency domain representation of part of the 2.4 GHz Industrial, Scientific and Medical (ISM) band comprising 802.11g and BLUETOOTH™ signals.

In particular, as shown in FIG. 5, at any given time, the BLUETOOTH™ signal occupies 1 of the 79 possible different hop channels, each spaced 1 MHz apart. The BLUETOOTH™ signal acts as a narrowband jammer to a WLAN signal with a probability of spectral overlap given by 6.5/79 or about 20% (since the occupied bandwidth of 802.11g is 16.5 MHz).

A prediction of the number of times that collisions will occur depends upon the duration of the BLUETOOTH and 802.11g packets. For instance, if single time slot packets (occupying 625 us) are used in the BLUETOOTH™ communications, then the use of ‘long’ 802.11g PSDUs at the low data rate (e.g., 2000 bytes in 6 Mbit/s mode) will almost certainly result in a collision (either fully or partially) from a narrowband BLUETOOTH™ signal essentially acting as a radio signal jammer to the simultaneous WLAN data packet. On the other hand, if a ‘short’ 802.11g PSDU (256 bytes) is sent, then the probability of collision is much smaller, since a proportion of the short 802.11g packets will be transmitted during the 59 us transient settling time between BLUETOOTH packets when the BLUETOOTH frequency has overlap with the WLAN channel.

FIGS. 6(a) to 6(d) show the effect of packet size on the probability of collision.

In particular, FIG. 6(a) shows BLUETOOTH 1 slot packets-different frequency every 625 us. FIG. 6(b) shows a ‘long’ (2000 byte in 6 Mbit/s mode) 802.11g packet. FIG. 6(c) shows ‘short’ (256 byte in 24 Mbit/s mode) 802.11g packets. FIG. 6(d) shows BLUETOOTH multi-time slot packets (a 3 slot packet and a single slot packet are shown).

The probability of 802.11g PSDUs being completely transmitted within the quiet time between transmission of BLUETOOTH™ packets depends upon the proportion of the time for which the BLUETOOTH transmitter is idle. For instance, longer BLUETOOTH packets have less transient settling time, so the corresponding probability of collision for a given PSDU length depends upon the duration of the 802.11g PSDU. For multi time slot BLUETOOTH packets, the probability of collision with a ‘long’ 802.11g PSDU is reduced, since the hop rate of BLUETOOTH is effectively reduced given that the entire multi time slot BLUETOOTH packet is transmitted on the same frequency.

To prevent mutual interference as much as possible, several coexistence schemes have been introduced, but each conventional approach solves only a part of the problem in a particular coexistence scenario.

One important parameter of a coexistence scenario is the separation in space between the antennas of the WLAN transceivers and the BT transceivers. If there is sufficient distance between the WLAN and the BT devices, simultaneous operation is possible if the BT network is restricted from hopping into the part of the 2.4 GHz band used by the WLAN network (multiplexing in frequency by Adaptive Frequency Hopping).

Adaptive frequency hopping (AFH) is a technique that enables a BLUETOOTH™ device to reduce the number of channels it hops across, leaving some channels open for other devices such as 802.11g.

For co-located devices however, the signal levels are generally too high, regardless of the used channels, and it is necessary to multiplex the transmissions of the BT and WLAN networks in time.

Another technique proposed to mitigate BLUETOOTH™ interference is the exploitation of space time block codes (STBC). STBC exploits antenna diversity on BLUETOOTH and (BLUETOOTH) WLAN enabled devices with maximum likelihood decoding.

Common WLAN data rate control methods provide data rate fallback in presence of interference from BLUETOOTH™ systems, microwave ovens and other devices operating in the 2.4 GHz band. With lower data rates, the duration of the frame transmission becomes longer and the probability of interference by a simultaneous BT transmission increases. Therefore, the WLAN MAC has to select shorter fragments for lower fallback data rates to reduce the risk of destructive interference during the frame transmission period.

Other conventional methods describe WLAN/BT coexistence problems in terms of a quantification of the problem, and suggest scheduling transmissions for the two devices to avoid overlap in time and frequency.

Yet other conventional techniques describe a control provision for co-located WLAN and BT devices to prevent some ways of simultaneous operation. Without such a provision, the WLAN and/or BT devices can corrupt each others reception.

The BT adaptive frequency hopping (AFH) scheme (supported by BT version 1.2) reduces WLAN/BT interference, particularly for devices that are not co-located.

While these partial solutions exist, owners and operators of 802.11g WLANs desiring robustness cannot entirely rely on these techniques. There is a need for a dependable, robust technique for reducing interference between WLAN and BT devices that are co-located.

### SUMMARY OF THE INVENTION

In accordance with the principles of the present invention, a method of coordinating wireless communications between a remote first wireless device that is co-located with a piconet device, comprises fragmenting a single data frame corresponding to the second wireless device into a plurality of fragmented data frames. A transmission of at least one of the plurality of fragmented data frames is timed by the remote first wireless device to occur during a non-occupied time slot for communications by the piconet device. As a result, frame loss due to interference between the second wireless device and the piconet device is minimized.

In accordance with another aspect of the present invention, a wireless communications device comprises a first wireless local area network (WLAN) device, and a piconet device co-located with the first WLAN device. A co-existence mechanism operates on a downlink from a remote second WLAN device to the first WLAN device that is co-located with the piconet device. The co-existence mechanism operates to fragment a single data frame corresponding to the remote second WLAN device into a plurality of fragmented data frames, and to time a transmission of at least one of the plurality of fragmented data frames from the remote second WLAN device to occur during a non-occupied time slot for communications by the piconet device. Frame loss due to interference between the first WLAN device and the piconet device is minimized.

### BRIEF DESCRIPTION OF THE DRAWINGS

Features and advantages of the present invention will become apparent to those skilled in the art from the following description with reference to the drawings, in which:

FIG. 1 shows a fragmentation of a WLAN data frame into a plurality of fragmented data frames, each fragment being transmitted by a remote WLAN device to a local WLAN device that is co-located with a piconet device, during the time of an idle, non-occupied time slot in a communication link established by the co-located device, in accordance with the principles of the present invention.

FIG. 2 illustrates the net throughput based on given efficiencies, and a net throughput factor (referring to the net throughput within the wireless LAN communications) of 0.85, 1.5, 3.85, 5.0 Mbit/s at 1, 2, 5.5 and 11 Mbit/s, respectively, in accordance with the principles of the present invention.

FIG. 3 shows optimum fragment durations of 1.1, 1.0, 0.8 and 0.75 ms, respectively, in accordance with the principles of the present invention.

FIG. 4 shows a TDD scheme used where master and slave alternatively transmit.

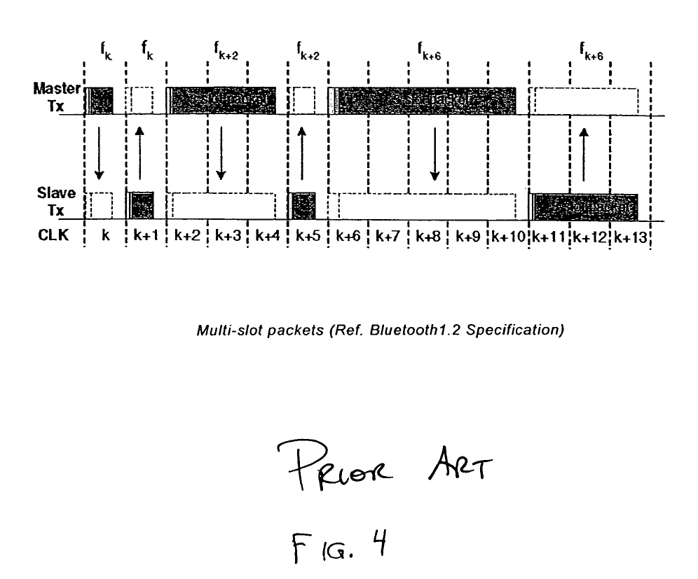

FIG. 5 shows a frequency domain representation of part of the 2.4 GHz Industrial, Scientific and Medical (ISM) band comprising 802.11g and BLUETOOTH™ signals.

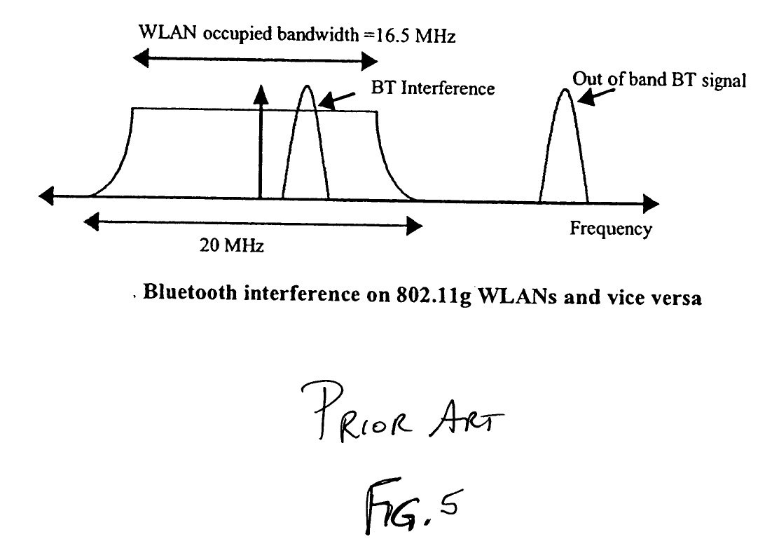

FIGS. 6(a) to 6(d) show the effect of packet size on the probability of collision.

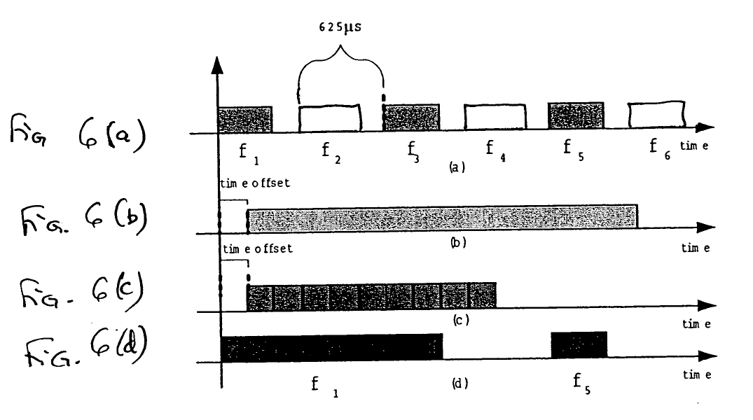

### DETAILED DESCRIPTION OF ILLUSTRATIVE EMBODIMENTS

The present invention relates to the communication between a WLAN client station proximate to, or co-located with a BLUETOOTH™ (BT) device, and a remote WLAN station, the latter typically being, but not limited to, a WLAN Access Point (AP). The invention serves to minimize the mutual interference experienced by the co-located WLAN and BT devices.

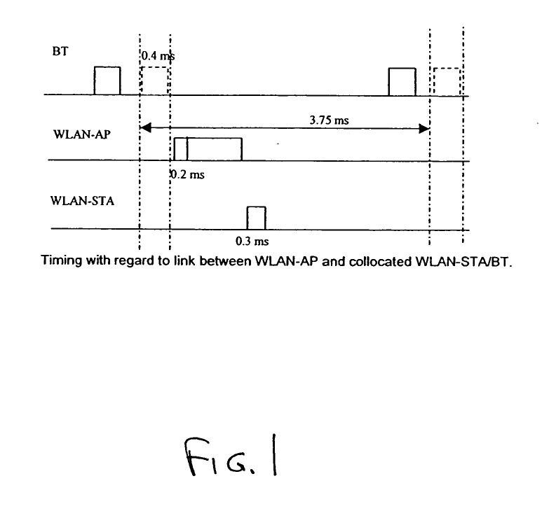

FIG. 1 shows a fragmentation of a WLAN data frame into a plurality of fragmented data frames, each fragment being transmitted by a remote WLAN device to a local WLAN device that is co-located with a piconet device, during the time of an idle, non-occupied time slot in a communication link established by the co-located device, in accordance with the principles of the present invention.

The present invention provides an improved wireless local area network (WLAN) scheme using fragmentation, that itself mitigates BLUETOOTH™-related interference, without relying on a presumed cooperation from co-located BLUETOOTH devices. The use of fragmentation in a WLAN network allows for a longer concatenated period of WLAN activity, with corrupted segments being retried. Thus, there may still be a series of fragments transmitted, and only one or some of the fragments need be retried. Therefore, the chances of getting a full frame transferred during times of repetitive interference by co-located BT activity is greatly improved.

The present invention defines a coexistence scheme that is active in the MAC layer of a Wireless LAN (WLAN) device, aiming to make optimal use of the non-occupied BT slots for both uplink and downlink WLAN communication. The co-existence scheme defined by the present invention improves throughput performance for active co-located WLAN and BT devices. Moreover, because the coexistence scheme is link-based instead of global and is enabled only when required, frame loss and fragmentation are minimized, thus leading to less network overhead.

When a WLAN client device and a BT device are co-located, it is generally impossible to receive a WLAN frame during a BT transmission, or to receive a BT frame during a WLAN transmission. A coexistence device can be introduced (e.g., as shown by device 106 in U.S. patent application Ser. No. 10/010,689 to Awater et al.) to schedule the transmissions in time, in such a way as to avoid the occurrence of a BT frame being transmitted when a WLAN device is receiving (or expecting, such as an ACK frame) a signal, and/or as to avoid the occurrence of a WLAN frame being transmitted when a BT device is receiving, or expecting to receive.

Importantly, in accordance with the principles of the present invention, a co-located WLAN/BT station fragments large WLAN frames to fit the fragmented frames in positions which correlate to the non-occupied BT transmission slots.

It is necessary to prioritize the transmissions of the co-located WLAN and BT devices, and with priorities based, e.g., on the communication mode of the two devices. For example, a BT voice mode could have the highest priority, while a WLAN data mode might have a higher priority than a BT data mode. A coexistence device in a co-located WLAN/BT device, however, cannot in general predict when frames from a remote WLAN station arrive (except for certain frame types). Therefore, in case a BT mode has priority, the reception of a WLAN frame could collide with the simultaneous transmission of a higher priority BT frame, or it could be impossible to transmit a WLAN acknowledgement, if a higher priority BT frame is being received or expected, both leading to the loss of the colliding WLAN frame. To this extent, the present invention provides a control scheme to activate a coexistence mechanism in the downlink from the remote WLAN station to the co-located WLAN/BT device.

The use of fragmentation improves operation of a WLAN device with downlink and uplink traffic.

Uplink Traffic: Short TCP ACK/REQ frames (40 byte payload) from the AP will normally be too short for fragmentation, while the longer payload frames from the co-located station can be fragmented. For the co-located device, there are two possibilities to apply fragmentation in combination with the abortion of a frame or ACK.

Firstly, to keep after the abort medium access due to the NAV and SIFS period, each fragment (re)defines the NAV with respect to a timer corresponding to the period for following fragment through (including) the ACK. This means that if fragment N is received correctly, the others have to stay away until the next fragment+ACK (fragment N+1+ACK) has been timed out. However, an early or late abort for fragment N+1, still means that SIFS maintains access for the WLAN station in question. Any other WLAN station has to use the DIFS. So, a single fragment can be skipped while keeping the medium access.

Secondly, after an abort without ACK frame, normal backoff is made. The figurative (non-802.11) will give a better behavior for the co-located device.

Downlink traffic: The short TCP ACK from the co-located device doesn't need to be fragmented, and can be transmitted when there is no BT transmission (e.g., BLUETOOTH voice). The AP will send long payload frames in an uncoordinated manner to the co-located device. Then, the BT packet can mutilate the reception, or can enforce an abortion of the ACK.

At a co-located WLAN-STA/BT device, the risks for receiving WLAN payload frames are in case of BT data (e.g., BT voice) are about the same for the uplink and downlink direction. Furthermore, there are some small differences between the situation with a master and with a slave.

Regarding an optimum fragment size with respect to the downlink payload transfer, assume that the co-located BT device (e.g., with HV3 voice) will block reception by the WLAN device during 0.4 ms once every 3.75 ms, and that it will also enforce an abortion of the ACK in case the ACK has to transmit during some part of the 0.4 ms. Also, assume that both the co-located WLAN and BT devices can receive simultaneously, and can transmit simultaneously. This is correct only in the case of AFH. If there is no AFH, then the risk of WLAN fragment loss will increase slightly.

With WLAN 802.11b, long training (˜200 us) the risk of fragment loss relates to overlap of the fragment+ACK transmission with 0.4 ms once every 3.75 ms. Thus, there is a free period of 3.75−0.4 (BT active TX)−0.2 (WLAN training)−0.3 (WLAN ACK)=2.85 ms. Then, the probability of non-lost fragments is given by:
(2.85/3.75)×(1-MAC fragment duration/2.85)

In a first embodiment, the co-located WLAN/BT device performs a management frame exchange with the remote WLAN station. In the management frame exchange, the co-located WLAN/BT device reports information about its active BT links, whenever such links are established or terminated. The exchanged data may include, but is not limited to, the used packet types and the assigned priorities of the active BT links. Using the received information, the remote WLAN station activates a fragmentation scheme in the downlink to the co-located WLAN/BT station. This fragmentation scheme will be data rate dependent, based on a probabilistic model of the BT packet exchange proceeding at the remote side, trading off the risk of frame loss in the WLAN downlink against the introduced fragmentation overhead, and thereby maximizing the WLAN throughput.

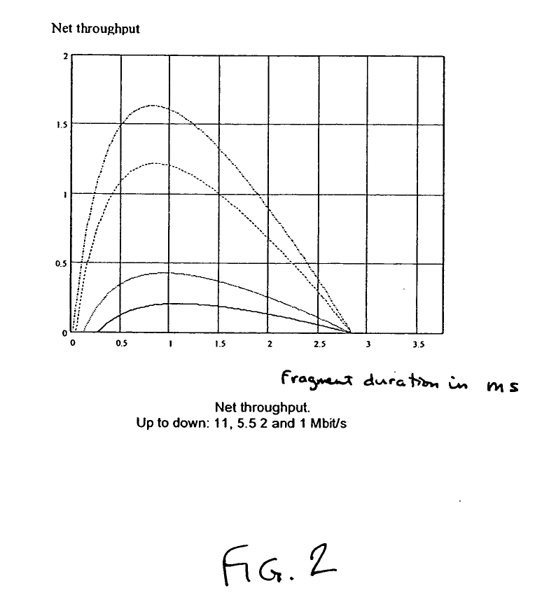

FIG. 2 illustrates the net throughput based on given efficiencies, and a net throughput factor (referring to the net throughput within the wireless LAN communications) of 0.85, 1.5, 3.85, 5.0 Mbit/s at 1, 2, 5.5 and 11 Mbit/s, respectively, in accordance with the principles of the present invention.

In particular, net throughput for exemplary data rates in the case of BT HV3 voice link activity is shown in FIG. 2, accounting for frame loss as a function of the fragmentation size. This model is used to select the optimum fragmentation size for the downlink. It will be clear to those of ordinary skill in the art that the required fragmentation scheme in the downlink is different from that in the uplink, since it is based on a probabilistic model instead of the actual BT slot timing.

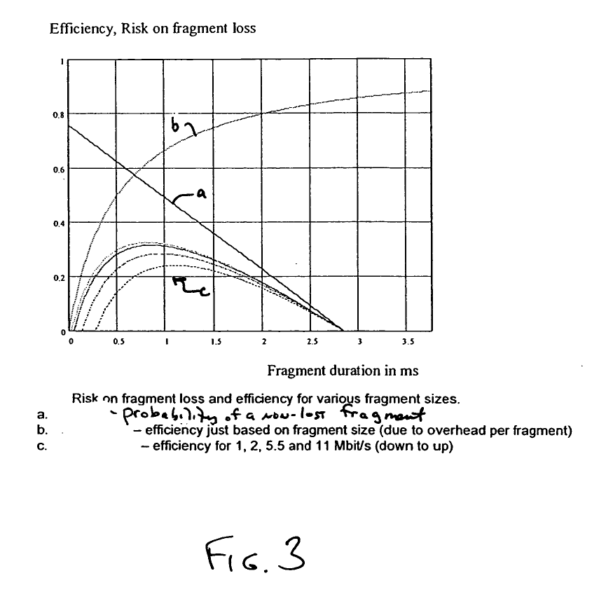

FIG. 3 shows optimum fragment durations of 1.1, 1.0, 0.8 and 0.75 ms, respectively, in accordance with the principles of the present invention.

In particular, net throughput scores are now 0.2, 0.4, 1.2 and 1.65 Mbit/s, respectively. The optimum fragment payload sizes are (after correction for the 34 byte MAC header) around 100, 220, 500 and 1000 bytes, respectively.

With a WLAN device having pure 802.11g conformance, data rates above 12 Mbit/s do not require fragmentation, and the efficiencies are much better than with 802.11b. This is due to less overhead, particularly with respect to preamble and ACK.

Thus, in a link between a WLAN-AP and a co-located WLAN-STA/BT, fragmentation should be implemented at both ends for conformance with 802.11b at lower data rates. Without fragmentation, a 1500 byte frame transmitted at 1 and 2 Mbit/s will not reach the end in presence of the BT data. With pure conformance to 802.11g, fragmentation techniques are desired at the lower data rates, and provides some advantage with 802.11b data rates of 5.5 and 11 Mbit/s. This applies to both BLUETOOTH without AFH as well as to BLUETOOTH with AFH.

When a co-located WLAN-STA/BT device is configured for BT coexistence with a WLAN-AP, then operation is with a combined data rate fallback/fragmentation scheme that provides fragmentation into 100 byte @ 1 Mbit/s, 220 byte @ 2 Mbit/s (and possibly 550 byte @ 5.5 and 6 Mbit/s). When another WLAN-STA (separated) is configured for the same combined data rate fallback/fragmentation for BT coexistence, the same fragmentation helps reduce interference from BT devices without AFH. When the WLAN is configured for the data rate fallback/fragmentation while there is no BT activity, the net throughput is slightly lower at the lower (influenced) data rates.

In a second embodiment of the invention, the control scheme described above is extended with a parameterized model of the BT slot timing. Using such a model, the remote WLAN station can reconstruct the BT slot timing. The additionally exchanged data are, e.g., the parameters of this model, which may include, but are not limited to, the offset between the WLAN timing and the BT timing, and the amount of drift between the WLAN timing and the BT timing. Using this information and the information about the active links, as described above, the remote WLAN station can schedule its downlink transmissions in time, preventing collisions with BT frames. The advantage of the second embodiment is that a lower frame loss can be achieved with less fragmentation, leading to a significantly higher downlink throughput.

In a preferred implementation of the co-located WLAN/BT device, the parameters of the timing model are constant and need to be exchanged only once per established BT link. This can however only be achieved if the BT device is the master of its piconet. In the more general quasi-stationary case, the control scheme will automatically re-transmit the timing model parameters whenever the deviation between the predicted timing and the actual timing exceeds a particular limit.

While the invention has been described with reference to the exemplary embodiments thereof, those skilled in the art will be able to make various modifications to the described embodiments of the invention without departing from the true spirit and scope of the invention.

1. A method of coordinating wireless communications between a remote first wireless device and a co-located piconet device, comprising:
fragmenting a single data frame corresponding to said second wireless device into a plurality of fragmented data frames; and
timing a transmission of at least one of said plurality of fragmented data frames by said remote first wireless device to occur during a non-occupied time slot for communications by said piconet device;
wherein frame loss due to interference between said second wireless device and said piconet device is minimized.

2. The method of coordinating wireless communications between a remote first wireless device and a co-located piconet device, further comprising:
performing a management frame exchange between said remote first wireless device and said piconet device.

3. The method of coordinating wireless communications between a remote first wireless device and a co-located piconet device according to claim 1, wherein:
said non-occupied time slot for communications by said piconet device relates to a transmission from said piconet device.

4. The method of coordinating wireless communications between a remote first wireless device and a co-located piconet device according to claim 1, wherein:
said piconet device is a BLUETOOTH™ device.

5. The method of coordinating wireless communications between a remote first wireless device and a co-located piconet device according to claim 1, wherein:
said fragmenting occurs only when required to avoid interference between said piconet device and said second wireless device.

6. A wireless communications device, comprising:
a first wireless local area network (WLAN) device;
a piconet device co-located with said first WLAN device; and
a co-existence mechanism operating on a downlink from a remote second WLAN device to said first WLAN device that is co-located with said piconet device, said co-existence mechanism operating to fragment a single data frame corresponding to said remote second WLAN device into a plurality of fragmented data frames, and to time a transmission of at least one of said plurality of fragmented data frames from said remote second WLAN device to occur during a non-occupied time slot for communications by said piconet device;
wherein frame loss due to interference between said first WLAN device and said piconet device is minimized.

7. The wireless communications device according to claim 6, wherein:
said non-occupied time slot for communications by said piconet device relates to a transmission from said piconet device.

8. The wireless communications device according to claim 6, wherein:
said piconet device is a BLUETOOTH™ device.

9. Apparatus for coordinating wireless communications between a remote first wireless device and a piconet device, in the midst of a second wireless device that is co-located with said piconet device, comprising:
means for fragmenting a single data frame corresponding to said second wireless device into a plurality of fragmented data frames; and
means for timing a transmission of at least one of said plurality of fragmented data frames by said remote first wireless device to occur during a non-occupied time slot for communications by said piconet device;
wherein frame loss due to interference between said second wireless device and said piconet device is minimized.

10. The apparatus for coordinating wireless communications between a remote first wireless device and a piconet device, in the midst of a second wireless device that is co-located with said piconet device according to claim 9, further comprising:
performing a management frame exchange between said remote first wireless device and said piconet device.

11. The method of coordinating wireless communications between a remote first wireless device and a piconet device, in the midst of a second wireless device that is co-located with said piconet device according to claim 9, wherein:
said non-occupied time slot for communications by said piconet device relates to a transmission from said piconet device.

12. The method of coordinating wireless communications between a remote first wireless device and a piconet device, in the midst of a second wireless device that is co-located with said piconet device according to claim 9, wherein:
said piconet device is a BLUETOOTH™ device.

13. The method of coordinating wireless communications between a remote first wireless device and a piconet device, in the midst of a second wireless device that is co-located with said piconet device according to claim 9, wherein:
said means for fragmenting performs said fragmenting only when required to avoid interference between said piconet device and said second wireless device.
